(19) United States
(12) Patent Application Publication
(10) Pub. No.: US 2005/0005522 A1
(43) Pub. Date: Jan. 13, 2005

(54) Mezzanine safety gate

(76) Inventor: John C. Benko, Westlake, OH (US)

Correspondence Address: John W. Renner;Renner, Otto, Boisselle & Sklar, LLP, 19th Floor, 1621 Euclid Ave., Cleveland, OH, 44115-2191, US

(21) Appl. No.: 10/614,520

(22) Filed: Jul. 7, 2003

(51) Int. Cl. E06B 3/68

(52) U.S. Cl. 49/50

(57) ABSTRACT

A mezzanine safety gate for a mezzanine staging area maintains a clear aisle along the edge of the mezzanine and is supported at the edge by two minimal depth posts. Swing gates are provided between the posts at the edge. The posts include a roller guide track supporting a three sided cage or railing adapted to enclose the staging area when down. They also support two vertically spaced guide tubes for vertically elongated counterweights connected to the cage by cable pulleys at the top. The swing gates include guide tubes aligned with the counterweight guide tubes when closed. Spring loaded gate hinges are offset from the gate guide tubes. When the counterweights enter the gate guide tubes the gates are locked shut. Linear cams on the cage swing the gate open after being unlocked.

### FIELD OF THE INVENTION

This invention relates generally as indicated to a mezzanine safety gate, and more particularly, to mezzanine safety gates assuring at all times adequate railing height protection in the gate area while providing aisle clearance when not in use.

### BACKGROUND OF THE INVENTION

Elevated storage and work platforms such as mezzanines are widely employed in industrial buildings. Mezzanines require safety railings for fall protection. Material to be placed on a mezzanine may often be stored on pallets and may be positioned on an edge of the mezzanine at a staging area from below by a forklift truck. From the staging area the pallet may be transferred along an aisle to a storage position by another forklift or dolly, for example. For economies of space, most mezzanines are organized so that a main or major aisle runs along the edge of the mezzanine and parallel to the edge.

Prior art safety gates sometimes use fixed railings at each side of the staging area with gates alternating between open and closed positions at the edge and the inner end of the staging area. An example is seen in applicants' prior U.S. Pat. No. 5,709,050, dated Jan. 20, 1998. While this safety gate is an effective low cost solution to mezzanine safety railing problems, its one drawback is that you can only exit or enter the staging area from the rear or substantially away from the edge of the mezzanine. This then requires any aisle along the edge of the mezzanine to be wider.

Accordingly, it would be desirable if a safety gate system could be provided where entry or exit with respect to the staging area could be in any direction parallel to, or away from the edge unencumbered by railings, stanchions or fixed frames. Even inboard stanchions such as seen in U.S. Pat. No. 4,422,264 can create interference. Moreover, the stanchions themselves may be subject to damage. Any stanchions employed should be rugged and should not project significantly beyond, or inwardly of the mezzanine edge.

It is also important that the loading or staging area be protected by a railing at a required height at all times, either around the interior or along the edge or ledge of the mezzanine.

If a ledge railing, and a railing around the interior of the loading area were mounted on a simple pulley so that as one goes up the other goes down, clearance problems may develop since both should be able to achieve an elevated position providing at least an eighty (80) inch clearance, either for people or palletized loads, and especially the latter since such loads need to be lifted before being moved or placed.

Because of the need for overhead clearance, situations may develop where neither the railing around the interior nor the gate at the ledge is at the proper protection height. It has been discovered that this problem can be alleviated by not moving the ledge gate vertically and moving vertically only the railing around the interior of the loading area.

It has been found that this can be accomplished with swing gates, which swing outwardly more than 90° to open the loading area at the edge. However, these gates need to be securely locked when closed and not unlocked for opening until the interior railing has achieved a required lower elevation. It is important that the swing gates, when locked, be rigidly locked to avoid accidental opening. It is also important that the locking and unlocking of the swing gates, as well as their opening and closing be controlled by a certain range of vertical movement of the cage or railing around the inner portion of the loading area.

### SUMMARY OF THE INVENTION

A mezzanine safety gate includes posts of minimal depth mounted on the ledge of the mezzanine to define a staging or loading area. A gate is provided between the posts at the ledge, which is normally closed and locked. A cage railing adapted to surround the interior of the loading area is mounted on the posts for vertical movement. The safety gate includes a connection between the cage and gate to unlock the gate when the cage achieves a lowered protective height around the loading area and further lowering of the cage causes the gates to swing open after being unlocked. The cage in its lower most position holds the gates open.

Conversely, as the cage starts moving upwardly, the gates automatically close and continued upward movement of the cage to its elevated clearance position firmly locks the gates closed.

This is accomplished by using two vertically elongated counterweights, which are attached through pulleys to the cage. When the cage is elevated the counterweights move downwardly through guide tubes and into gate tubes, which are offset from the gate hinge pivots. Continued downward movement of the counterweights telescope them into bottom guide tubes so that the counterweights extend completely through the gate tube.

The gate is not unlocked until the counterweight is pulled from the gate tube upon lowering of the cage, all of which may be done by hand.

The cage includes two linear cams, which engage the gates to force them open after they are unlocked as the cage further descends. By the time the gates are unlocked the lower edge of the cage has already achieved proper safety railing height.

The gates include torsion springs in the hinges, which maintain the gates in contact with the operative edges of the linear vertically moving cams. The gates also include pads ensuring the gates, when shut, won't bounce open or misalign the gate tubes with the pulley guide tubes before the gates are fully locked.

To the accomplishment of the foregoing and related ends the invention, then, comprises the features hereinafter fully described and particularly pointed out in the claims, the following description and the annexed drawings setting forth in detail certain illustrative embodiments of the invention, these being indicative, however, of but a few of the various ways in which the principles of the invention may be employed.

### BRIEF DESCRIPTION OF THE DRAWINGS

FIG. 1 is a side elevation of the safety gate at the edge of a mezzanine with the cage down and the gate open, but showing the cage up in phantom lines in the aisle clearing position;

FIG. 2 is a top view with the cage down and gate open;

FIG. 3 is a front view with the cage up and gate closed;

FIG. 4 is an enlarged fragmentary horizontal section illustrating a gate hinge and the offset gate tube as seen from the line 4-4 of FIG. 1;

FIG. 5 is an enlarged partial view of one spring loaded gate hinge;

FIG. 6 is a fragmentary elevation of one of the cage counterweights;

FIG. 7 is a side elevation of one of the linear cams mounted on the cage;

FIG. 8 is a front elevation of the cam seen in FIG. 7 with the opposite cam seen in FIG. 4 being a mirror image of the cam shown;

FIG. 9 is a side elevation showing the position of a counterweight down, bridging the two guide tubes and extending through the gate tube locking the gate closed when the cage is in the up aisle clearing position; and

FIG. 10 is a similar view showing the cage down, but the counterweight up clearing the gate tube and the gate open.

### DESCRIPTION OF PREFERRED EMBODIMENTS

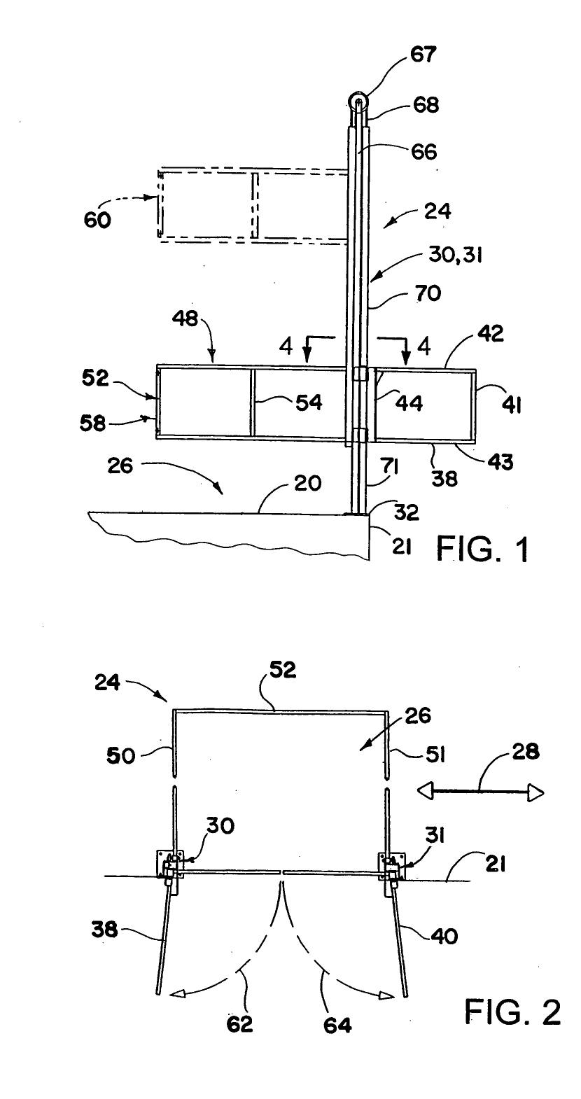

Referring first to FIGS. 1-3, 9, and 10, there is illustrated an elevated mezzanine 20 which includes an edge or ledge 21 on which the safety gate shown generally at 24 is mounted. The safety gate defines a loading or staging area shown generally at 26 on the mezzanine and the staging area may normally be in an aisle way that runs parallel to the edge of the mezzanine as indicated by the double end arrow 28 in FIG. 2.

The main structure of the safety gate assembly is provided by posts 30 and 31, each mounted on pedestal plates 32 which may be fastened or anchored directly to the mezzanine floor at the four corners of the plates.

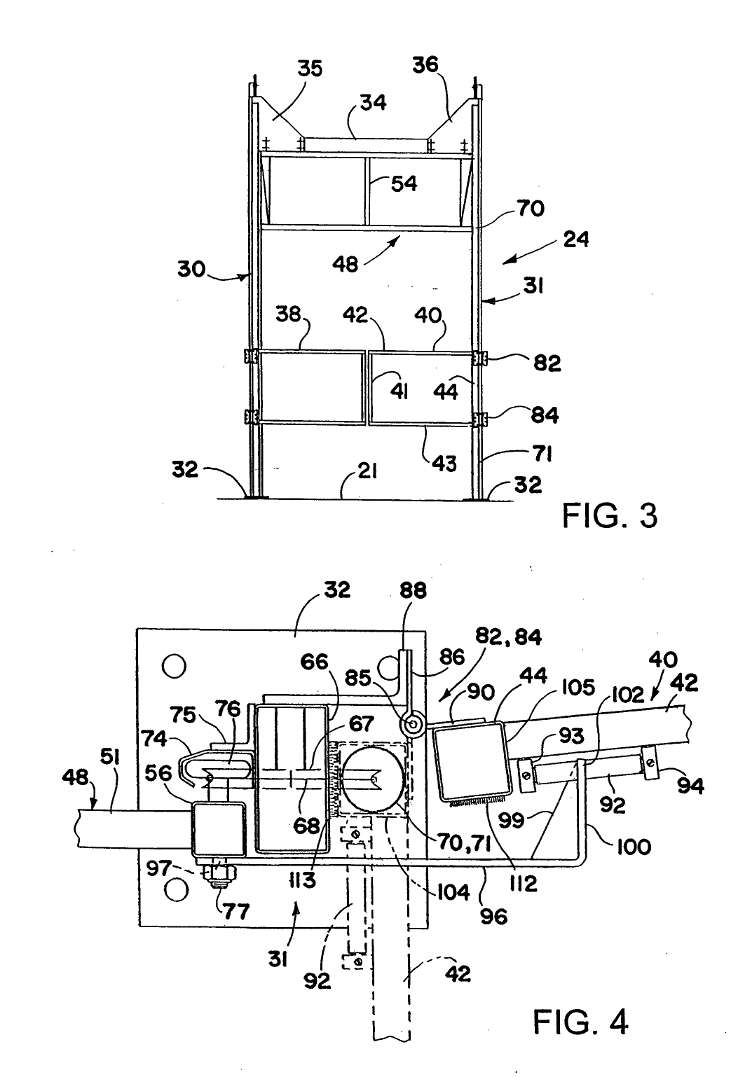

As seen in FIG. 3, the upper ends of the two post assemblies are interconnected by structural framing 34 connected between stiffening or gusset plates 35 and 36 mounted on the respective posts. When anchored to the mezzanine floor the interconnected posts form a rigid structure defining the ledge or edge section of the staging area 26 in the aisle way of the mezzanine.

The post assemblies are provided with vertically fixed, but horizontally swinging gates shown at 38 and 40. Each gate section is relatively simple and each includes only four (4) structural elements including distal vertical frame member 41, horizontal top and bottom frame members 42 and 43, and proximal tubular frame member 44. The tubular frame member 44 is generally square in section and is open at the top and bottom and somewhat enlarged as hereinafter described.

It is noted that when the gate sections are closed there is a slight gap between the distal vertical elements 41 and the two gate sections are not interconnected when the gate is closed. The gate sections are above the floor of the mezzanine and the top horizontal frame member 42 of each gate section is at railing height.

Also supported between and from the posts cantilevering away from the edge is a railing cage shown generally at 48. As seen more clearly in FIG. 2 the railing cage 48 includes side railings 50 and 51 and a connecting railing 52. Each of the three (3) sides of the railing cage includes top and bottom horizontal railing members interconnected by vertical struts at the two corners and also at the mid-points of each side as indicated at 54. Relatively larger tubular struts interconnect the horizontal railings of the cage at the posts as seen at 56 in FIG. 4. The various vertical and horizontal struts of the cage make a rigid three (3) sided railing system adapted to enclose the staging area at railing height and which may be moved from the solid line down position 58 as seen in FIG. 1 to the phantom line elevated clearance position 60, also shown in FIG. 1. Thus the posts 30 and 31 support the cage railing for vertical movement and they also support the gate sections 38 and 40 for horizontal swinging movement as seen by the arrows 62 and 64 in FIG. 2.

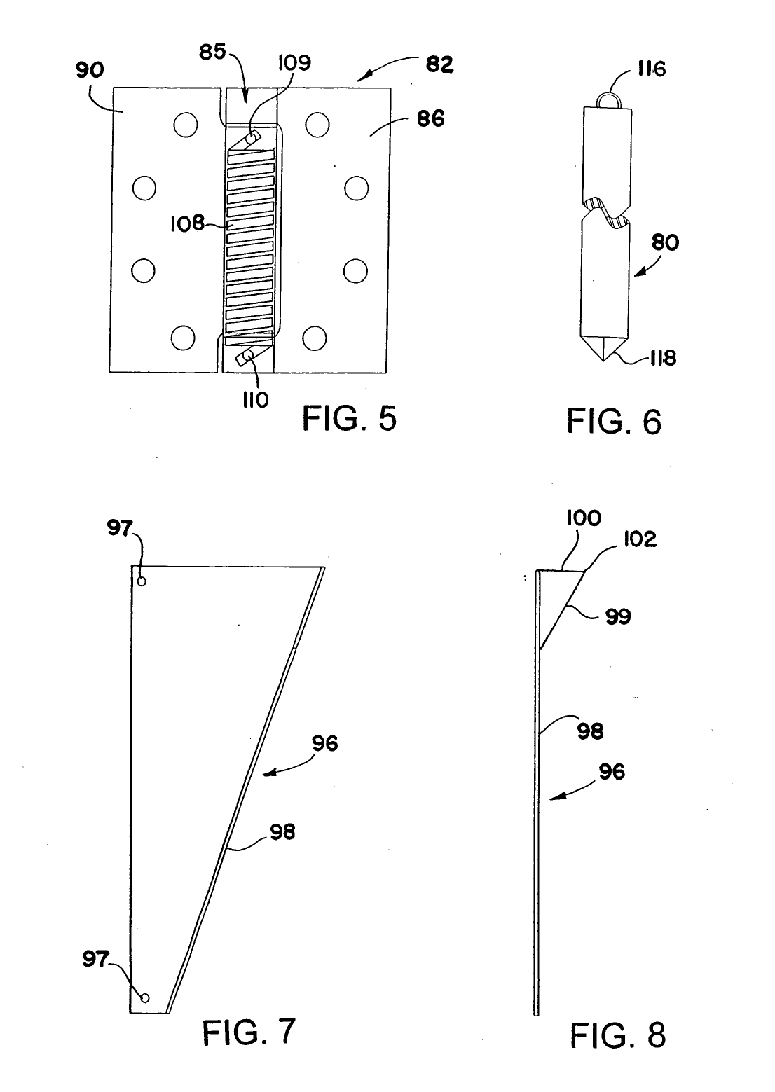

Referring now more particularly to FIG. 4 there is illustrated the details of the post assembly construction. The posts include an upright rectangular tubular element 66 projecting upwardly from the plate or footing 32. The top of each post structure is provided with a pulley or sheave 67 over which is trained a cable 68. The side of each post toward the front, or as facing the viewer in FIG. 3, is provided with two vertically spaced counterweight guide tubes seen at 70 and 71. These guide tubes are above and below the horizontally swinging gate sections. On the rear of each post there is provided a roller track 74 secured in place by brackets 75. Positioned in the track are vertically spaced rollers 76 mounted on studs 77 extending from the somewhat enlarged tubular frames 56. The cable 68 extends over the sheave or pulley at the top of the post and interconnects a vertically elongated counterweight with the roller mounted railing cage guided within the tracks 74. The counterweight in FIG. 4 is above the plane of the section but is illustrated at 80 in FIGS. 5, 6, 9, and 10. As the railing cage 48 goes up and down along the tracks on the posts, the counterweights move conversely.

Referring now to FIGS. 4 thru 8, it will be seen that the gate sections 38 and 40 are hinged by vertically spaced hinge assemblies shown at 82 and 84 providing pivot 85. The fixed leaf 86 of each spring is secured to an angle bracket 88 in turn secured to the end of the main post structure 66. The opposite leaf 90 is secured to the enlarged vertical tubular strut 44 of the gate. The top horizontal strut 42 of the gate section 40 is provided with an elongated roller 92 journaled between blocks 93 and 94 fastened to the interior of the strut 42. The roller 92 is engaged by cam 96 which is mounted on the interior of the vertical strut 56 of the roller cage as indicated at 97.

The cam 96 at its upper edge includes a right angle bend 100 and provides an angled cam surface which extends upwardly and outwardly as seen at 98 and then veers off at the angle 99 to the tip 102 of the right angle bend. The cam on the opposite side of the safety gate engaging the opposite swing gate section is a mirror image of the cam seen in FIGS. 4, 7, and 8. Thus vertical downward movement of the cage causes the cam edge 98 to engage the roller 92 in the dotted line position seen in FIG. 4 causing the gate to swing open about the pivot 85 of the hinge 82. Continued downward movement of the cage will cause the gate to swing in a counterclockwise direction as seen in FIG. 4 about the pivot 85 with the roller 92 initially engaging the inclined cam surface 98 and then finally the cam surface 99 to achieve the solid line position seen in FIG. 4. In such position the gate section has opened more than 90°. It is appreciated that the gate section 38 on the opposite side will open in a similar fashion by engagement of the cam on the opposite side of the cage which is a mirror image of the cam seen in FIGS. 4, 7 and 8.

Importantly, it will be noted that the enlarged guide tube 44 of the gate section has moved from the dotted line position 104 to the solid line position 105. In the dotted line position with the gate closed, the tube 44 which is open both top and bottom is aligned with the fixed counterweight tubes 70 above and 71 below seen in FIGS. 3, 9 and 10. Because of the offset between the vertical center axis of the three tubes 70, 44 and 71, and the hinge pivot 85, the gate is locked shut until the counterweight is vertically lifted from the guide tube 44 in the closed position seen at 104 in FIG. 4. Conversely, the gate sections need to be closed and shut with the guide tube 44 in the aligned position 104 before the counterweight 80 can enter the tube 44.

To ensure that the gate section is closed each of the hinges 82, 84 is provided with torsional springs seen at 108 in FIG. 5. The springs may surround the hinge pins and one end is connected to one leaf at 109 while the other end is adjustably connected to the other leaf lt 110. These torsional springs in each of the hinges are then adjustable to provide the desired closing force so that as the cage and two cams elevate the springs will hold the gate sections so that the rollers 92 are maintained in engagement with the cams and the gates swing shut automatically.

To ensure that the proper alignment of the tube 44 is maintained when the gates are shut, the tube 44 is provided with a pad seen at 112 on the interior of the tube 44 which will mate with a similar pad 113 on the post section 66. The two pads may be simple adhesive VELCRO® pads which not only cushion the closing of the gates, but once closed maintain the gates in the proper alignment and keep them from bouncing as the counterweights descend. Since the cage section is designed to be raised and lowered manually the VELCRO® pads are designed to cushion and hold the gate sections in the proper closed position as the counterweights descend into the guide tubes 44.

The counterweights shown in detail in FIG. 6 may be elongated solid or tubular devices designed to balance the weight of the cage railing to enable it to be moved up and down manually. The top of each counterweight is provided with an eye 116 to facilitate attachment of the cable 68 and is also provided with a pointed lower end 118 to facilitate its insertion into the guide tube 44 and the bottom guide tube 71.

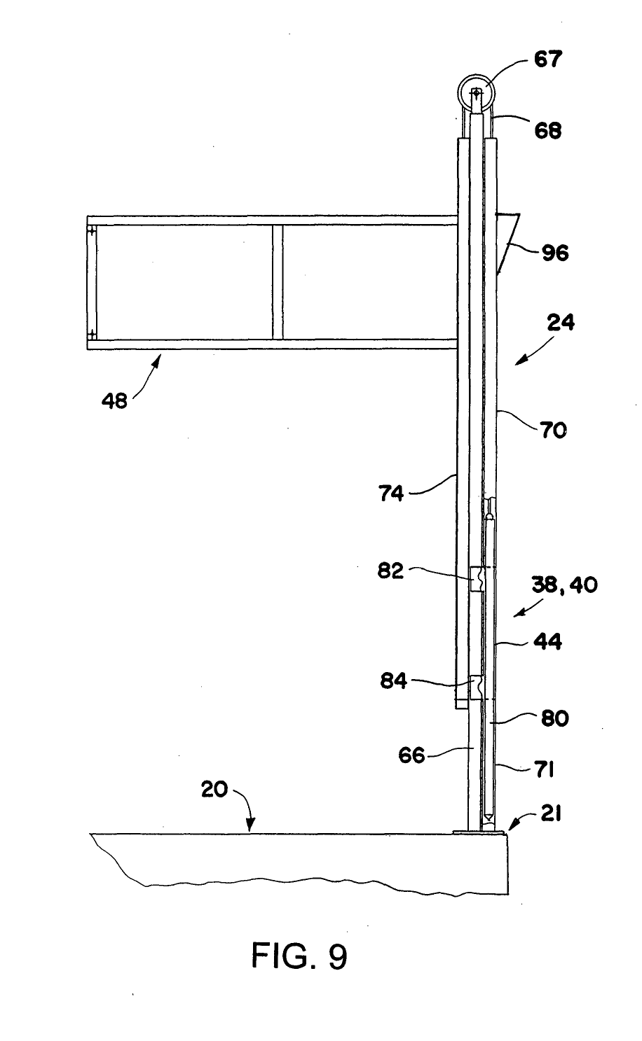

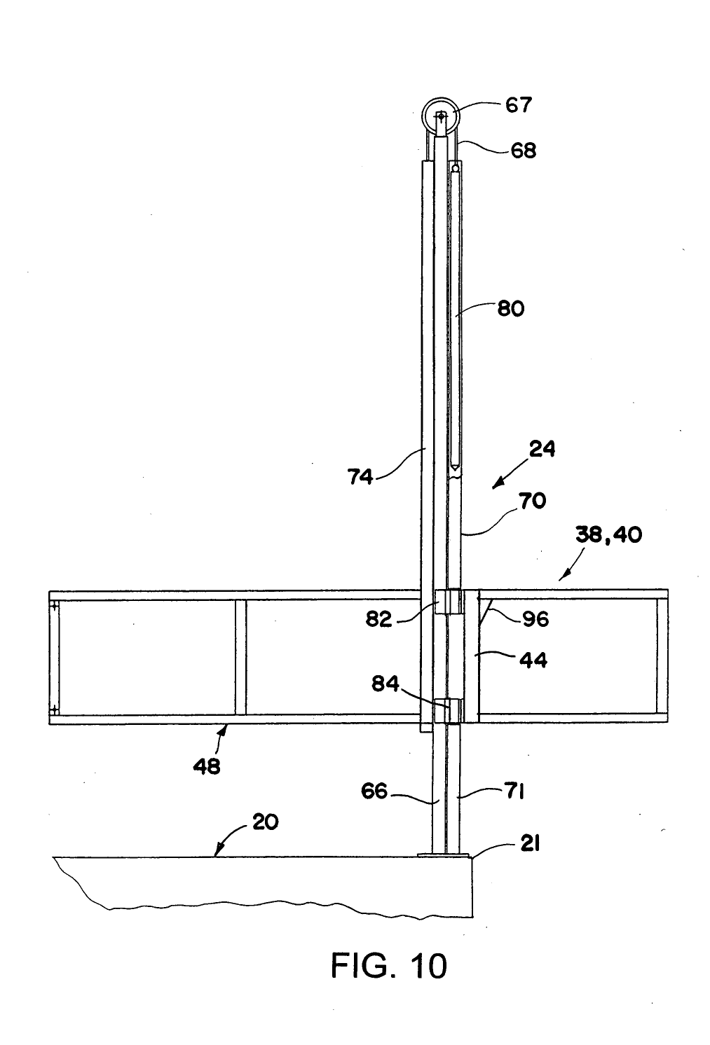

The counterweights function not only to facilitate the manual elevation and lowering of the cage railing, but importantly they also function with the guide tubes to lock the swing gates at the edge of the mezzanine closed when the cage is up. This function of the counterweights is perhaps best seen in FIGS. 9 and 10 where the three guide tubes 70, 44, and 71 are broken away to illustrate the counterweight.

In FIG. 9 the cage 48 is up and the counterweights 80 are down. In such position the cage railing 48 has a clearance over the staging area of at least 80 inches and provides a clear aisle way normal to the plane of FIG. 9 parallel to the edge 21. With the cage up and the counterweights down it will be seen that the counterweights extend from the upper guide tube 78 through the gate guide tube 44 and into the lower guide tube 71. Because the guide tube 44 is offset from the hinge pivot of the gates, the two gate sections are rigidly locked closed and each counterweight acts as a rigid vertical bar preventing the gates from swinging about their pivots.

Referring now to FIG. 10 it will be seen that the cage 48 has been pulled down so that it constitutes a railing around the staging area at proper railing height. As the cage comes down the counterweight 80 moves up first pulling out of the tube 71 and then pulling out of the tube 44 in the gate sections and on up into the tube 70. When the counterweights clear the tubes 44 the gate sections are then unlocked and free to swing open. Continued downward movement of the cage 48 causes the cams to engage the gate sections swinging them outwardly as seen in FIGS. 1, 2, 4 and 10. It is noted that as the gates swing outwardly, the guide tube 44 swings off center the guide tubes 70 and 71 and is thus axially offset from such guide tubes. It is also believed apparent that the range of motion of the counterweights from the position seen in FIG. 10 to the top of the guide tube 44 and vice versa is the range of movement of the cage which controls the opening and closing of the gates. Accordingly, as the counterweights 80 come down in FIG. 10 the cage 48 goes up as do the cams on the cage permitting the gates to swing closed as the cams ascend. By the time the counterweight reaches the top of the guide tube 44 it will be aligned with the guides tubes 70 and 71 and held in place by the aforenoted pads. Continued elevation of the cage railing permits the counterweights to telescope into the tubes 44 and through the tubes into the lower counterweight guide tubes 71. When the cage has reached its elevated clearance position the gate sections 38 and 40 are not only closed but rigidly locked in place. During the range of movement parameters described, there will always be a railing around the staging area at railing height. For example, the bottom horizontal portions of the cage 48 will achieve the height of the top of the swing gates before the swing gates are fully unlocked with continued downward movement to the position seen in FIG. 10 then opening the unlocked gates.

It will also be seen from FIGS. 1, 9 and 10 that the post structures even with the interior tracks and exterior guide tubes offer little in the way of interference to movement along an aisle parallel to the edge. The entire post assemblies are not significantly deeper than the normal edge railing.

In any event, there is provided a mezzanine safety gate including posts mounted at the edge of a mezzanine, with a gate between the posts, and a cage mounted on the posts for vertical movement, with means responsive to the vertical downward movement of the cage first to unlock the gate and then to open the gates, and vice versa.

Although the invention has been shown and described with respect to certain preferred embodiments, it is obvious that equivalent alterations and modifications will occur to others skilled-in the art upon the reading and understanding of this specification. The present invention includes all such equivalent alterations and modifications, and is limited only by the scope of the claims.

1. A mezzanine safety gate including posts adapted to be mounted at the edge of a mezzanine, a gate between said posts, normally closed and locked, a cage mounted on said posts for vertical movement, and means responsive to the location of said cage during vertical downward movement to unlock said gate.

2. A mezzanine safety gate as set forth in claim 1 including means to open said gate responsive to continued downward movement of said railing.

3. A mezzanine safety gate as set forth in claim 2 including a counterweight for said cage operative to lock the gate shut in one position and unlock the gate in an other position.

4. A mezzanine safety gate as set forth in claim 3 including a hinge for said gate, and a guide tube on said gate for said counterweight offset from the hinge.

5. A mezzanine safety gate as set forth in claim 4 wherein said means to open the gate comprises cam means on said cage.

6. A mezzanine safety gate as set forth in claim 5 including a portion of said cam means positioned to cause said gate to swing more than 90°.

7. A mezzanine safety gate as set forth in claim 6 including a right angle bend on said cam means, and a roller on said gate operative to engage the cam.

8. A mezzanine safety gate as set forth in claim 7 including a spring on said gate to maintain the gate roller in contact with the cam.

9. A mezzanine safety gate as set forth in claim 8 including pad means to maintain the gate closed for alignment with the counterweight.

10. A mezzanine safety gate as set forth in claim 4 including a guide tube for said counterweight both above and below the guide tube on said gate.

11. A mezzanine safety gate including posts mounted at the edge of a mezzanine, a gate between said posts, a cage mounted on said posts for vertical movement, and means responsive to vertical upward movement of said cage first to close said gate and then to lock the gate.

12. A mezzanine safety gate including posts mounted at the edge of a mezzanine, a gate between said posts, a cage mounted on said posts for vertical movement, and means responsive to vertical downward movement of said cage first to unlock said gate, and then to open said gate.

13. A mezzanine safety gate comprising posts adapted to be positioned adjacent the mezzanine edge, a gate extending between said posts at the edge, a cage railing supported by said posts and adapted to be raised and lowered, and means responsive to a range of movement of said cage railing approaching and leaving the mezzanine to open and close said gate respectively.

14. A mezzanine safety gate as set forth in claim 13 wherein said last mentioned means includes means to unlock and lock said gate.

15. a mezzanine safety gate as set forth in claim 14 wherein said gate is a swing gate blocked against swinging when locked.

16. A mezzanine safety gate as set forth in claim 15 including cam means to open and close the gate when unlocked.

17. A mezzanine safety gate as set forth in claim 16 wherein said cam means is mounted on said cage railing for vertical movement therewith.

18. A mezzanine safety gate as set forth in claim 15 wherein said last mentioned means is a counterweight attached to said cage railing.

19. A mezzanine safety gate as set forth in claim 18 wherein said counterweight telescopes into and out of a gate guide tube on said gate.

20. A mezzanine safety gate as set forth in claim 19 wherein said gate includes a hinge pivot offset from said gate guide tube.

21. A mezzanine safety gate as set forth in claim 20 including a fixed guide tube for said counterweight.

22. A mezzanine safety gate as set forth in claim 21 including fixed guide tubes for said counterweight above and below said gate.
